(19) United States
(12) Patent Application Publication
(10) Pub. No.: US 2024/0131549 A1
(43) Pub. Date: Apr. 25, 2024

(54) CASTING DEVICE, SYSTEM AND METHOD OF CASTING AN MFC FILM

(71) Applicant: Stora Enso OYJ, Helsinki (FI)

(72) Inventors: Otto Nylèn, Helsinki (FI); Riku Pihko, Jyväskylä (FI); Vesa Kunnari, Tuulusa (FI); Marko Kraft, Palokka (FI)

(73) Assignee: Stora Enso OYJ, Helsinki (FI)

(21) Appl. No.: 18/547,374

(22) PCT Filed: Feb. 23, 2022
(86) PCT No.: PCT/IB2022/051586

§ 371 Date: Aug. 21, 2023

(30) Foreign Application Priority Data
Feb. 26, 2021 (SE) 2150208-3

(51) Int. Cl. B05C 3/18; B05C 1/08; B05C 9/10; D21H 23/40

(52) U.S. Cl. CPC B05C 3/18; B05C 1/0826; B05C 1/0865; B05C 9/10; D21H 5/0015

(57) ABSTRACT

A device (4) for applying a viscous liquid, in particular an MFC dispersion, onto a moving substrate (52) comprises an inlet (72, 73a-73f) for the viscous liquid, a casting chamber (61a, 61b), a lower portion of which being open to the substrate (52), and a metering portion (69, 661), for limiting a thickness of a wet film that is formed on the substrate downstream of the device. The device further comprises a shear section (42) arranged inside the casting chamber (61a, 61b). The shear section (42) comprises a fluidization rod (68), arranged in the casting chamber (61a, 61b), for providing shearing of the viscous liquid inside the casting chamber (61a, 61b).

### TECHNICAL FIELD

The present disclosure relates to a casting device for producing MFC films. The disclosure relates particularly to a casting device which provides a high quality MFC film, as well as to a system for casting an MFC film and to a method of casting an MFC film using such casting device.

### BACKGROUND

Microfibrillated cellulose (“MFC”) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

Current research indicates that MFC may be a suitable material for packaging and coating of packaging, due to its barrier properties. Hence, MFC has the potential of replacing or supplementing currently used barrier films, including polymer and metal films.

Forming of MFC films can be achieved by solvent casting of a viscous or gel-like fluid material on a continuous conveyor belt, followed by dewatering/drying (e.g. evaporation) of the solvent.

The term “solvent casting” is a known term designating methods wherein a film is produced by applying a wet film comprising a film forming component which is distributed in a medium that is to be essentially removed, for example by dewatering and/or evaporation. The film forming component may be dispersed in a dispersing medium or dissolved in a solvent, hence the term “solvent casting”.

In the following, the term “MFC dispersion” will be used as reference to a dispersion/suspension or solution containing MFC. The MFC dispersion will be in a viscous state.

Forming a film from the MFC dispersion presents a challenge, in that t has very high viscosity, and thus does not flow freely as a normal liquid would. Moreover, the MFC dispersion has a tendency to flocculate and clog flow channels and cavities in the casting device and other equipment used upstream of the film forming operation, such as in flow channels of the film applicator or upstream of the point where the MFC dispersion is applied to the substrate on which the MFC film is to be cast.

A known solution is to dilute the MFC dispersion. However, such dilution is associated with a considerable increase in the cost of drying the cast film.

Such a solution is disclosed in WO2013060934A1 and WO2020110013A1.

In case an MFC dispersion is diluted, the low viscosity of the thus diluted MFC dispersion also causes problems when a coating or film is deposited on the substrate, as it has a tendency to spill and dribble, especially in high speed movement of the substrate.

Furthermore, in fabrication of free-standing films, the edge profile of the MFC film needs to be very steep. This requires certain minimum level of viscosity, and with low viscous dilute MFC dispersion, the layer of wet MFC dispersion will pour down and form indistinct edges that are not sharp. These edges dry faster than the rest of the film, which creates many problems, such as deviating adhesion from the substrate and ripping of the film at the point where the MFC film is to be detached from the substrate.

Hence, there is a need for improvements in the casting of MFC dispersion on a substrate. In particular, there is a need for improved casting devices, which are capable of forming a high quality MFC film also from an MFC dispersion with a high solids content.

### SUMMARY

It is an object to provide a casting device and a method of producing an MFC film, which provide improved MFC film quality, preferably with limited or no increase in production cost and more preferably with a reduction in production cost.

The invention is defined by the appended independent claims, with embodiments being set forth in the appended dependent claims, in the following description and in the attached drawings.

According to a first aspect, there is provided a device for applying a viscous liquid, in particular an MFC dispersion, onto a moving substrate, comprising an inlet for the viscous liquid, a casting chamber, a lower portion of which being open to the substrate, and a metering portion, for limiting a thickness of a wet film that is formed on the substrate downstream of the device. The device further comprises a shear section arranged inside the casting chamber. The shear section comprises a fluidization rod, arranged in the casting chamber, for providing shearing of the viscous liquid inside the casting chamber.

A fluidization rod is a rotatable member, which may be driven to rotate at speeds of about 3000-10000 rpm, preferably 3000-5000 rpm or about 4000 rpm.

By using a fluidization rod inside the casting chamber, it is possible to reduce the risk of flocculation taking place, and introduce a shear-thinning effect in the viscous liquid, and thus to enhance the properties of the film formed by the device.

The device of the present disclosure enables production of an improved free-standing MFC film as well as production of an improved MFC coating on a substrate. An improved casting profile (i.e. reduced unevenness of the casting profile) may be obtained and the blockage of the casting device and associated channels may be reduced. By subjecting a viscous liquid in the form of an MFC solution or dispersion to shear-force mixing in the casting chamber of the casting device, aggregated or agglomerated fibrils may be separated from each other by being impacted by shear forces provided by the shear-force mixing in the casting chamber. Thereby, the amount and/or size of flocs and bundles in the fibrous dispersion may be reduced in the casting chamber, i.e. the amount and/or size of flocs and bundles in the fibrous dispersion, may be reduced immediately before casting of the fibrous dispersion onto a substrate. Since the decomposition of flocs and bundles is provided in the casting chamber, i.e. immediately before casting, the time for renewed self-aggregation or agglomeration is very limited.

There is also provided improved wet edge quality since levelling at edges can be controlled and adjusted more precisely. This will improve yield but also winding and reel quality for the dry film. For a wide web, the difference between edge thickness and e.g. average film thickness for dry film may be significantly improved.

The device is particularly suitable for forming a film from an MFC dispersion having a solids content of about 2.5-25% by weight, preferably about 2.5-15% by weight, about 2.5-10% by weight or about 2.5-8% by weight, and a viscosity which is above about 4 Pas at a shear rate of 20 s⁻¹. The viscosity is determined for a dispersion at a temperature of about 20-80 deg C. and preferably about 20-60 deg C.

In particular, the solids content may be about 2.5-4% by weight, about 4-6% by weight, about 6-8% by weight, about 8-10% by weight, about 10-12% by weight, about 12-14% by weight, about 14-16% by weight, about 16-18% by weight, about 18-20% by weight, about 20-22% by weight or about 22-25% by weight.

The shear section may be configured for shearing of the viscous liquid between the shear section and the substrate.

The fluidization rod may extend across a width of the casting chamber. Hence, the fluidization rod may be rotatable about a geometric axis which is parallel with a surface of the substrate and perpendicular to the direction of movement of the substrate.

The fluidization rod may have an effectively non-smooth surface.

In the present context, a smooth surface implies a smooth, such as polished, cylindrical surface.

A non-smooth surface may be e.g. sectorized, thus presenting a plurality of axially or helically extending edges, or it may be grooved, having a plurality of axially or helically extending grooves. Such grooves may present a polygonal or curved cross section. As yet another alternative, the non-smooth surface may have ridges protruding from an otherwise cylindrical surface. Such ridges may present a polygonal or curved cross section. It is also possible to provide a non-smooth surface on the fluidization rod by arranging a wire helically around and along the rod. Such helical wire may be releasably adhered or otherwise permanently connected to the rod surface.

A radius of the fluidization rod may be 5-25 mm, counted from its geometric axis of rotation to its radially outermost point.

The fluidization rod may be connected to a drive device, configured to cause the fluidization rod to rotate.

The metering portion may comprise a metering rod.

The metering rod may have a downwardly convex surface.

The metering rod may have a bending radius of about 5-25 mm.

The metering rod may be arranged so as to be spaced from the substrate, i.e. so as not to contact the substrate.

The metering rod may have a substantially smooth cylindrical surface.

The metering rod may be rotatable.

The metering rod may be caused to rotate along the substrate, such that a relative speed between the substrate and the metering rod surface is reduced.

Alternatively, the metering rod may be caused to rotate against the substrate, such that a relative speed between the substrate and the metering rod surface is increased.

For example, the metering rod may be freely rotatable.

Alternatively, the metering rod may be connected to a drive device, configured to cause the metering rod to rotate.

As another alternative, the metering rod may be non-rotatable.

A non-rotatable metering rod implies that the rod is fixedly arranged, such that it cannot rotate.

The metering rod may have a release edge extending axially of the metering rod.

The metering rod may present at least one spacer extending along a direction of curvature of at least a portion of the metering rod, which faces the substrate.

The metering portion may comprise an upper lip, wherein an application slot is formed between the upper lip and the substrate.

The fluidization rod may be upwardly spaced from any fixed object n the casting chamber by a distance of at least 25% of a radius of the fluidization rod, preferably at least 50% or at least 100%.

The fluidization rod may be spaced in the upstream direction from any fixed object in the casting chamber by a distance of at least 25% of a radius of the fluidization rod, preferably at least 50% or at least 100%.

The device may further comprise a divider wall, which divides the casting chamber into an upstream section and a downstream section.

The shear section may be configured to provide said shearing of the viscous liquid when the viscous liquid passes from the upstream section towards the downstream section.

The device may further comprise a manifold device, configured to divide the inlet into at least two inlet subflow channels, which connect to the casting chamber, wherein the inlet subflow channels are spaced from each other along said casting chamber width.

At least some of the subflow channels may present a regulating valve, configured for regulating a flow in the respective subflow channel.

The device may further comprise a seal, for sealing the casting chamber against the substrate at an upstream portion of the casting chamber.

According to a second aspect, there is provided a device for applying a viscous liquid, in particular an MFC dispersion, onto a moving substrate. The device comprises an inlet for the viscous liquid, a casting chamber, which extends across a casting chamber width corresponding to an intended film width. The device further comprises a manifold device, configured to divide the inlet into at least two inlet subflow channels, which connect to the casting chamber. The inlet subflow channels are spaced from each other along said casting chamber width.

The device according to the second aspect is also particularly suitable for forming a film from an MFC dispersion having a solids content of about 2.5-25% by weight, preferably about 2.5-15% by weight, about 2.5-10% by weight or about 2.5-8% by weight, and a viscosity which is above about 4 Pas at a shear rate of 20 s−1. The viscosity is determined for a dispersion at a temperature of about 20-80 deg C. and preferably about 20-60 deg C.

In particular, the solids content may be about 2.5-4% by weight, about 4-6% by weight, about 6-8% by weight, about 8-10% by weight, about 10-12% by weight, about 12-14% by weight, about 14-16% by weight, about 16-18% by weight, about 18-20% by weight, about 20-22% by weight or about 22-25% by weight.

At least one of the subflow channels may be provided with an adjustable valve.

Hence, it is possible to adjust the flow in at least one, preferably all, of the subflow channels, whereby a pressure distribution within the casting chamber may be adjusted.

The manifold device may comprise a manifold chamber, wherein a manifold inlet and the inlet subflow channels connect to the manifold chamber, and where a return channel is connected to the manifold chamber for allowing recirculation of the viscous liquid out of the manifold chamber.

According to a third aspect, there is provided a system for producing a film from an MFC dispersion, comprising a substrate, onto which the film is to be formed, and a device as described above, arranged such that a lower portion of the casting chamber is open to the substrate.

In applications where it is desired to provide a film only, the substrate may be an endless substrate, such as a steel belt, from which the film may be stripped for further processing and/or winding onto a reel.

In applications where a coated substrate is desired, the substrate may be a continuous web of e.g. a pulp based material, such as paper or cardboard, whereby the film may be formed on and adhered to the substrate. The thus coated substrate may be further processed and/or wound onto a reel.

The system may further comprise a drying section, wherein the substrate is configured to be passed through the drying section downstream of the device.

The movable substrate may be an endless belt, in particular an endless steel belt.

The metering portion may present a gap, which is limited in one direction by the substrate.

According to a fourth aspect, there is provided a method of producing an MFC film, comprising providing an MFC dispersion, using a device as described above to apply the MFC dispersion onto a surface of a substrate, while the substrate is caused to move relative to the device, such that a wet MFC film is formed on the substrate, and subjecting the wet MFC film to a drying process to remove liquid from the MFC dispersion.

The MFC dispersion may comprise a film forming component which is distributed in a medium that is to be essentially removed to form a dry film. A content of the medium of the MFC dispersion is at least 75% by weight, preferably more than 80% by weight, more than 85% by weight, more than 90% by weight or more than 95% by weight. The film forming component may comprise, consist or consist essentially of MFC, optionally with one or more water soluble polymers which may operate as co-additives and/or co-film formers.

The medium may comprise water and optionally one or more solvents.

In the context of the present application, a dry film is a film having a medium content of 0.1-15% by weight.

The film forming component may be dispersed in a dispersing medium, whereby the dispersing medium is to be essentially removed. Alternatively, the film forming component may be dissolved in a solvent, whereby the solvent is to be essentially removed. In any event, the MFC dispersion is in a viscous liquid stage when the casting takes place.

The film forming component may comprise MFC and one or more property-modifying additives and/or fillers. Preferably, the film forming component comprises at least 50% by weight of MFC, preferably at least 60%, at least 70% or at least 80% MFC. For example, the film forming component may also comprise other natural fibre material in addition to the MFC.

Hence, in the MFC dispersion, the MFC content may be about 1.25% by weight to about 25% by weight, preferably about 1.8% by weight to about 10% by weight or about 2.8% by weight to about 8% by weight.

The film forming component optionally also comprises a water soluble polymer that can form a film and/or improve bonding between cellulose fibrils. Typical non-limiting examples of such polymers are e.g. natural gums or polysaccharides or derivatives thereof such as e.g. CMC, starch, or PVOH or analogues thereof.

The MFC dispersion may have a solids content of 2.5-25% by weight, preferably 2.5-20% by weight, 2.5-15% by weight, 2.5-10% by weight or 2.5-8% by weight, and a viscosity which is above 4 Pas at a shear rate of 20 s⁻¹. A preferred method of measuring viscosity is by use of a rheometer using bop-cup mode, such as an Anton Paar MCR 302 dynamic rotational rheometer. The viscosity is determined for a dispersion at a temperature of about 20-80 deg C. and preferably about 20-60 deg C.

The film may have a weight in the range of about 4-80 g/m², which may correspond to a thickness in the range of about 5-60 μm.

The average film thickness may be about 5-60 μm, preferably about 10-50 μm, about 15-45 μm or about 20-40 μm.

A film weight may be about 4-80 g/m², preferably about 8-67 g/m², about 12-60 g/m², about 16-53 g/m² or about 20-45 g/m².

A medium content of the film may be about 0.1-15% by weight, preferably about 1-12% by weight or about 2-10% by weight.

Measurements in terms of % by weight for a dry film are given in relation to the dry weight of the film.

A film forming component content of the film may be at least about 85-99.9% by weight.

The film forming component may comprise at least 50% by weight of MFC, preferably at least 60%, at least 70% or at least 80% MFC.

Hence, in some embodiments, an MFC content of the dry film may be at least about 42.5% by weight. In other embodiments, the MFC content of the dry film may be at least about 79.92% by weight.

A film width may be about 0.3-4 m, preferably 0.5-4 m, 1-4 m or 2-4 m.

According to a fifth aspect, there is provided an MFC film produced according to the method as described above.

### BRIEF DESCRIPTION OF THE DRAWINGS

FIG. 1 is a schematic diagram of a system for producing an MFC film.

FIG. 2 is a schematic diagram of a film forming process according to a first embodiment.

FIGS. 3a-3b are schematic views of a film forming device according to one embodiment.

FIGS. 4a-4b are schematic views of a film forming device according to another embodiment.

FIG. 5 is a schematic view of a film forming device according to yet another embodiment.

FIG. 6 is a schematic cross sectional view of a version of a fluidization rod.

FIG. 7 is a schematic cross sectional view of another version of a fluidization rod.

FIG. 8 is a schematic cross sectional view of yet another version of a fluidization rod.

FIG. 9 is a schematic cross sectional view of another version of a metering rod.

FIG. 10 is a schematic diagram of a variant of a manifold device for distributing pressure in the film forming device.

### DETAILED DESCRIPTION

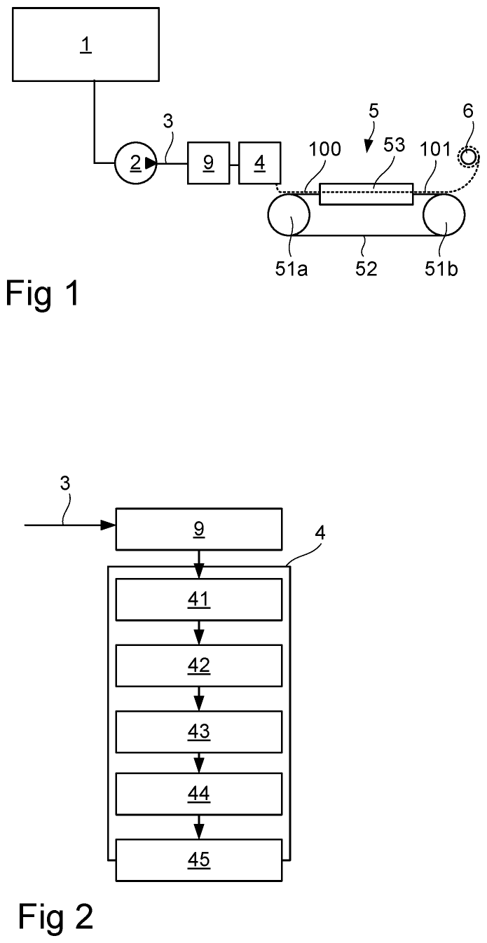

FIG. 1 schematically illustrates an equipment for manufacturing an MFC film. The equipment comprises a vessel 1, in which an MFC solution or dispersion is provided. A pump 2 is used to convey the MFC solution or dispersion through a feeding pipe 3, optionally via a first shearing section 9, to a film forming device 4, through which the MFC solution or dispersion is applied as a wet film 100 to a substrate 52, which may form part of a belt dryer 5.

In the illustration, the substrate 52 forms part of a dryer, such as a belt dryer, in which the substrate 52 may be an endless belt formed of metal or polymer material. The belt 52 may run between a pair of belt pulleys 51a, 51b and through a drying zone 53, which provides a climate (in terms of temperature, pressure and flow) that is adapted for removing the liquid part of the MFC solution or dispersion, so as to leave a film 101 that is sufficiently dry for being stripped off the substrate 52 and subsequently wound onto a reel 6. Before the drying step, the wet film may be subjected to a press dewatering step. Prior to such press dewatering, the wet film can be heated or subjected to hot air in order to facilitate the mechanical dewatering.

Between the stripping from the substrate 52 and the winding onto the reel 6, the film may undergo further processing steps, such as stretching, further drying or press dewatering.

In other configurations, more than two pulleys may be used, in particular where the coating is to be permanently arranged on the substrate.

Alternatively, the substrate 52 may be a continuous sheet or film material on which the MFC solution or dispersion is to form an MFC film that is to remain attached to the substrate 52. Non-limiting examples of such substrates include paper, cardboard, textile, nonwoven or polymer film materials. The substrate may also be a continuous MFC film, which may consist of one or more layers. Such a substrate may be used as a standalone substrate or be formed on any of the other substrate types mentioned above.

The exact position of a film deposition point provided by the film forming device 4 in relation to the first pulley 51a can be varied, typically at about 6-12 o'clock, preferably at about 9-12 o'clock, in relation to the first pulley 51a as illustrated in FIG. 1. In particular embodiments, the film forming device 4 may be positioned at about 10-11 o'clock or at about 11-12 o'clock.

FIG. 2 schematically illustrates a film forming device 4, which is connected to the feed line 3 from the pump 2.

Immediately upstream of the film forming device 4, there may be provided a first shearing section 9, configured to provide a shear rate of more than 20 s⁻¹, preferably more than 30 s⁻¹. The first shearing section 9 may comprise a screen, a dispersing homogenizer, a static mixer or a mesh filter.

Where a rotating screen is used, it is recommended to use a slot maximum width of 0.25 mm, with an average MFC dispersion flow through the screen of 0.005 m/s. In some embodiments, a distance to the film forming device 4 from the first shearing section 9 may be no more than 2 m. It may be preferred if a time it takes for the flow to move from the first shearing section 9 to the film forming device 4 is less than 10 seconds, preferably less than 5 seconds or less than 2 seconds.

Various types of rotating screen devices are known. For the purpose of the present disclosure, shear rates as mentioned above, for materials as mentioned above may be achieved using a closed rotor and radial vane pulsation elements and screen basket made by rods with 3.6 mm thickness that are 0.25 m apart, thus forming slits of 0.25 mm through which MFC dispersion or dispersion may flow.

A total open area of slits may be 0.00612 m² and MFC flow may be approx. 2 l/min, creating an average shear rate of about 22 s⁻¹ through the slits of screen basket.

Another example of a device that can be used for the first shearing section 9 is a screen having an open rotor with foils and screen basket made by rods with 2.5 mm thickness that are 0.25 mm apart, thus forming slits of 0.25 mm. A total open area may be 0.00315 m². MFC dispersion flow may be approx. 2 l/min, creating average shear rate 42 s⁻¹ through the slits.

Where a static mixer, such as a IMAMIX DN15/R½″ TYPE B6 PN10 HST, is used, a distance to slot input of no more than 1 m is recommended. Hence, such static mixers are known, and typically comprise a channel enclosing an approximately helical vane or otherwise spiral vane.

The film forming device 4 may further comprise a cross machine distribution section 41, which is configured to distribute the MFC solution or dispersion in the cross-machine direction.

The cross-machine direction distribution section 41 may be configured to maintain a shear rate of more than 10 s⁻¹.

Subsequently to the cross machine direction distribution section 41, an additional shearing section 42 may be configured to provide a shear rate of more than 100 s⁻¹, preferably more than 200 s⁻¹.

The additional shearing section 42 comprises a rotatable rod, such as a fluidization rod, inside a chamber of the film forming device 4. Additionally, this shearing section 42 may comprise a narrow flow channel inside a slot die applicator that accelerates the MFC solution or dispersion into movement.

The film forming device 4 may further comprise a shear release section 43, which is configured to decelerate the flow in the film forming device 4. A shear release section may be formed as a section having an increased flow area, which will cause flow speed to reduce.

The film forming device 4 may further comprise a third shearing section 44, which may be configured to provide a shear rate of more than 100 s⁻¹, preferably more than 200 s⁻¹.

The third shearing section 44 may comprise a narrow flow channel, a lip channel, a channel formed by the substrate and a coating blade, a bar or a rod.

At least one of the shearing sections may be configured to provide a shear rate of about 10 s⁻¹ to about 20 s⁻¹, about 20 s⁻¹ to about 30 s⁻¹, about 30 s⁻¹ to about 100 s⁻¹, about 100 s⁻¹ to about 200 s⁻¹, about 200 s⁻¹ to about 1000 s⁻¹, about 1000 s⁻¹ to about 5000 s⁻¹, about 5000 s⁻¹ to about 10000 s⁻¹, about 10000 s⁻¹ to about 50000 s⁻¹, about 50000 s⁻¹ to about 70000 s⁻¹ or about 70000 s⁻¹ to about 100000 s⁻¹.

The film forming device also comprises a film deposition section 45, which may comprise a slot-die applicator, a rod applicator or a metering blade applicator.

Where a slot-die applicator is used, a pressure on the order of 1-4.5 bar, preferably 1-2.5 bar, may be used.

After the wet film 100 has been deposited onto the substrate 52, it will be carried by the substrate through the drying zone 53. The drying zone may present a length and environment that are suitable for achieving the necessary drying to remove the liquid phase from the MFC solution or dispersion to form the MFC film 101.

In cases where the substrate 52 is fixed to the dryer 5, such as in a belt dryer, the substrate 52 may be formed of a metal or polymer material, which may have a very smooth surface to facilitate removal of the film from the substrate 52.

Before the drying step, the wet film may be subjected to a press dewatering step.

Subsequent to the drying, the MFC film 101 may be stripped off the substrate 52 in a manner which is known per se. The film may subsequently be processed further, such as by stretching, radiation, cutting, etc. so as to provide a film having desirable properties. The finished film 101 may be rolled onto a roll 6.

Alternatively, the substrate may be a material that is merely passed through the dryer 5, such as a polymer, fabric, nonwoven or paper based web, on which the MFC film 101 is to form an integrated coating. Subsequent to the drying, the MFC film 101 may be rolled or otherwise converted together with the substrate to form a roll of film covered substrate, or to form e.g. a plurality of sheets of film covered substrate.

The description will now focus on a casting device which may be used to provide the second and third shear sections as described above.

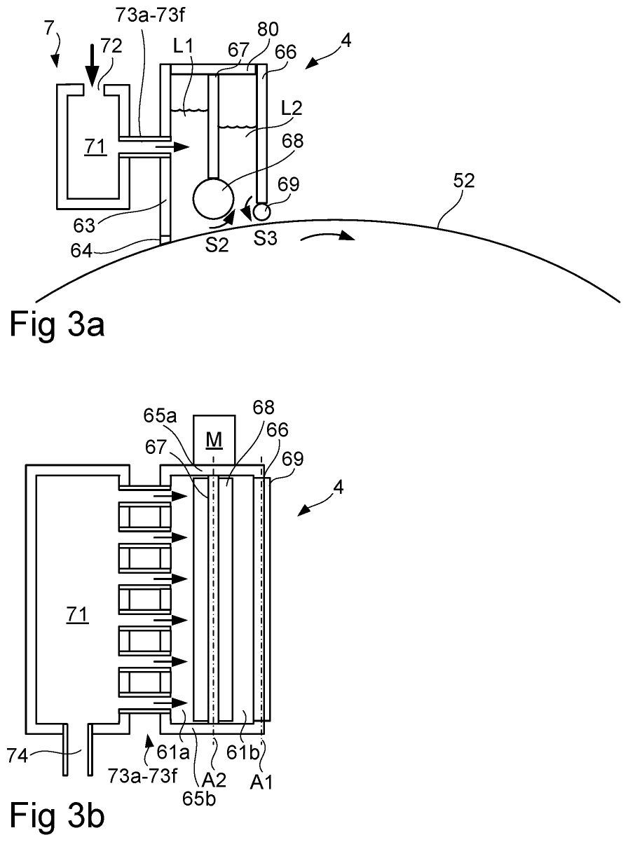

FIGS. 3a-3b schematically illustrate a film forming device 4 according to a first embodiment.

In FIG. 3a, there is illustrated a movable substrate 52, which may be a planar or curved substrate.

In some embodiments, the substrate may be an endless belt, such as a steel belt or a polymer belt, which has a surface from which a film may be readily removed. Such film may optionally be further processed before being rolled onto a reel or cut into sheets.

In other embodiments, the substrate may be a flexible sheet material, such as a pulp based web, onto which the film is formed as a coating, intended to be integrated with the substrate. Such substrate may be wound onto a reel subsequent to the drying step.

The film forming device comprises a casting chamber 61a, 61b, which is limited in an upstream direction by an upstream chamber wall 63 and which is limited in a downstream direction by a downstream chamber wall 66.

The upstream chamber wall 63 may be sealed against the substrate 52. Such sealing may be achieved by a seal 64.

A casting chamber inlet 73a-73f may be provided at an upstream portion 61a of the casting chamber.

Laterally, the casting chamber 61a, 61b may be limited by chamber side walls 65a, 65b.

Upwardly, the casting chamber 61a, 61b may be limited by a chamber lid 80. Hence, the casting chamber may be effectively closed from the surrounding environment. In some embodiments, the liquid in the chamber may fill the entire space formed by the chamber. To this end, a non-return valve may be provided for ventilating any gas entering the chamber.

The chamber may comprise one or more divider walls 67, which may divide the chamber into an upstream portion 61a and a downstream portion 61b. The divider walls 67 may provide restricted passages between the upstream chamber 61a and the downstream chamber 61b.

Hence, it is possible to utilize the divider wall to distribute pressure from one or more inlets 73a-73f into the upstream chamber 61a, such that a more even pressure is achieved over the width of the casting chamber at the downstream side of the divider wall 67.

In some embodiments, the chamber may enclose some gas, such as air, in which case a liquid level L1, L2 of the chamber portions 61a, 61b may differ, in particular such that there may be a higher liquid level L1 in the upstream chamber 61a than in the downstream chamber 61b.

In other embodiments, the chamber may be closed, and optionally ventilated, as described above, in which case the liquid level may be the same in the upstream chamber 61a and in the downstream chamber 61b.

In the chamber 61a, 61b, there is a fluidization rod 68 arranged. The fluidization rod may comprise a metal rod, which may be solid or hollow and which may be rotatably arranged and connected to a drive device M, configured to cause the fluidization rod 68 to rotate about a fluidization rod axis A2. Typical rotation speeds may be on the order of about 3000-10000 rpm, preferably 3000-5000 rpm and in particular about 4000 rpm.

In open systems, i.e. systems where air or other gas is allowed into the casting chamber 61a, 61b, the fluidization rod 68 may be completely immersed, and preferably also sufficiently spaced from a surface, such that no gas is mixed into the MFC dispersion.

The fluidization rod may extend over most of the width of the chamber, such as over at least 90% of the width, preferably at least 95% or at least 99%.

The fluidization rod 68 may have a diameter of about 10-50 mm. The diameter may be chosen with respect to the width of the chamber 61a, 61b, so as to reduce bending of the fluidization rod 68 due to its own weight.

The fluidization rod 68 may, in some embodiments have a smooth cylindrical surface, such as a polished surface.

In other embodiments, the fluidization rod may have a non-smooth outer surface. Referring to FIG. 6, which shows an exaggerated schematic view of an embodiment of a fluidization rod 68, the fluidization rod may have a sectioned cross section, exhibiting one or more ridges or edges 681 or grooves which may run in parallel with a geometric axis of rotation of the fluidization rod. Such ridges or grooves may present a polygonal or curved cross section. Alternatively, such edges may run approximately helically around and along the geometric axis of rotation.

Referring to FIG. 7, which shows an exaggerated schematic view of an embodiment of a fluidization rod 68, the fluidization rod may have one or more grooves 682, which are recessed into an otherwise substantially cylindrical surface, and which may run in parallel with a geometric axis of rotation of the fluidization rod. Alternatively, such grooves 682 may run approximately helically around and along the geometric axis of rotation.

Referring to FIG. 8, which shows an exaggerated schematic view of an embodiment of a fluidization rod 68, the fluidization rod may have one or more ridges 683, which protrude from an otherwise substantially cylindrical surface, and which may run in parallel with a geometric axis of rotation of the fluidization rod. Alternatively, such ridges 683 may run approximately helically around and along the geometric axis of rotation.

In either case, a variation in radial extent of the fluidization rod, between a minimum radial extent, e.g. at a groove bottom, and a maximum radial extent, e.g. at a ridge peak, may vary on the order of 3-20% of the maximum radial extent.

Experiments have shown that a variation in radial extent may be about 0.5-2 mm, preferably about 1-1.5 mm, regardless of the radius of the fluidization rod.

The fluidization rod 68 may be positioned spaced from the substrate surface 52. A spacing may be on the order of 10-100% of a maximum radius of the fluidization rod, such that a gap is provided between the fluidization rod and the substrate surface.

This gap thus forms part of the second shear section 42.

In some embodiments, the fluidization rod 68 may be freely arranged in the chamber 61a, 61b, in the sense that the fluidization rod is vertically spaced from any object, such as walls 67 or lids 80 by a distance which is at least 25% of a fluidization rod maximum radius, preferably at feast 50% or at least 100%.

The fluidization rod may also be horizontally spaced from any object, such as walls 63, 66, 67 by a distance which is at least 25% of a fluidization rod maximum radius, preferably at least 50% or at least 100%.

In other embodiments, the fluidization rod 68 may be arranged near a wall 63, 66, 67 or a lid 80, so as to provide a gap which is on the order of 1-25% of a fluidization rod maximum radius.

In a casting chamber 61a, 61b, there may be provided one or more fluidization rods 68. For example, two or three fluidization rods may be provided.

Furthermore, the fluidization rod or rods 68 may be temperature controlled, e.g. by provision of a heated or cooled fluid being supplied through the rod, or by provision of an electric heater in the fluidization rod.

At the downstream wall 66, a third shear section 44 is provided. This shear section 44 is limited by the surface of the substrate 52 and by a lower part of the downstream wall.

In some embodiments, the lower part of the downstream wall 66 may be provided with a metering rod 69.

Such a metering rod 69 may present a downwardly convex surface, which provides a gap between the rod 69 and the substrate 52 surface, which diminishes toward a minimum gap that is greater than zero. For example, the gap may be in the range of about 60 to about 2400 μm, which may correspond to a dry film thickness of about 3 to about 60 μm.

The metering rod 69 may be fixedly attached at the downstream wall 66 and may in some embodiments be attached to, and optionally integrated with, the downstream wall 66.

Such as fixed rod may have an effectively cylindrical or otherwise oval surface, whereby a gap downstream of the minimum gap gradually increases.

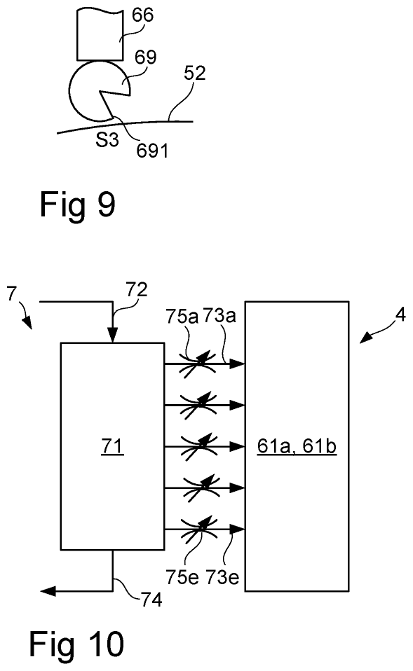

Alternatively, the fixed rod may have a release edge 691 (FIG. 9), which abruptly increases the gap downstream of the minimum gap.

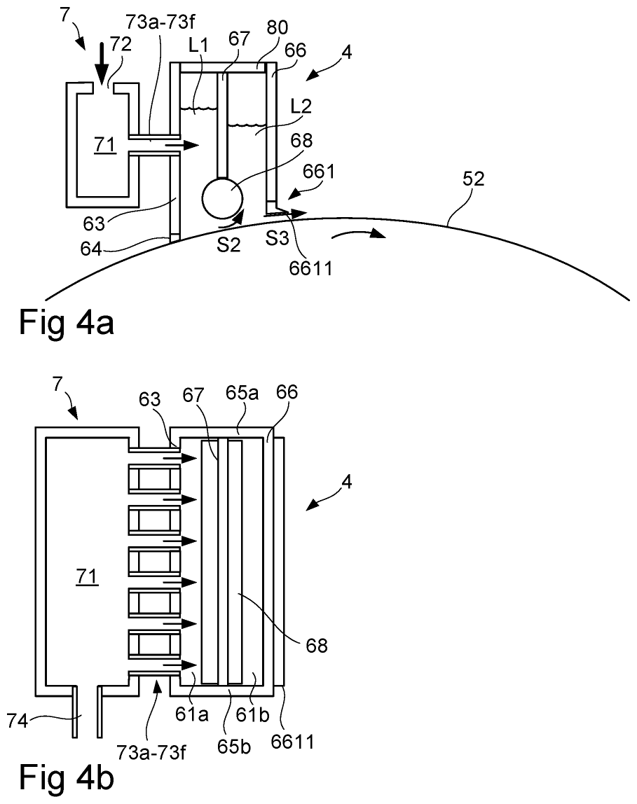

Referring to FIG. 4a, in other embodiments, the downstream wall 66 may be provided with a metering bar 661 having an upper lip 6611, effectively providing a gap that is of substantially constant height along the substrate 52,

In other embodiments, the metering rod 69 may be rotatable about a metering rod rotation axis A1. In such embodiments the metering rod may have a smooth cylindrical surface.

The metering rod 69 may be freely rotatable, or static.

Alternatively, the metering rod 69 may be connected to a drive device that causes the metering rod to rotate.

For example, the metering rod may be caused to rotate along with the substrate, at a same speed as the substrate, at a higher or at a lower speed.

As another example, the metering rod may be caused to rotate against the substrate.

As an additional component, which is optional, a manifold device 7 may be provided upstream of the casting chamber 61a, 61b.

The manifold device may comprise a manifold chamber 71, which has a manifold inlet 72 for the liquid and a plurality of manifold outlets, which form inlets 73a-73f to the casting chamber 61a, 61b. The inlets 73a-73f may be distributed over the width of the casting chamber 61a, 61b, so as to reduce the risk of pressure gradients over the width of the casting chamber 61a, 61b.

The manifold chamber 71 may, but need not, have a manifold return channel 74, from which liquid that does not find its way through the outlets to the casting chamber may be recirculated. This return channel 74 may be connected to the vessel 1, to the inlet of the pump 2 or to the first shear section 9.

The manifold chamber 71 may have a shape of converging cone, in a way that a manifold inlet side of the manifold chamber has a larger cross-section and the opposite side of the manifold has smaller cross-section.

The manifold chamber can be provided as a separate component, which is connectable to the casting chamber 61a, 61b, or as an integrated component, which may be fixedly connected to the casting chamber.

FIGS. 4a-4b schematically illustrate a film forming device 4 according to a second embodiment. In FIGS. 4a-4b, parts having the same function as in FIGS. 3a-3b have been given the same reference numerals and will not be described further.

The embodiment disclosed in FIGS. 4a-4b differs from the one in FIGS. 3a-3b in that a metering bar 661 having an upper lip 6611 is provided rather than a metering rod. Hence, a slot may be formed between the substrate 52 and the metering bar 661.

The slot may have a substantially constant height as seen along a flow direction. At a downstream portion of the metering bar 661 there may be provided a sharpened trailing edge at the upper lip 6611.

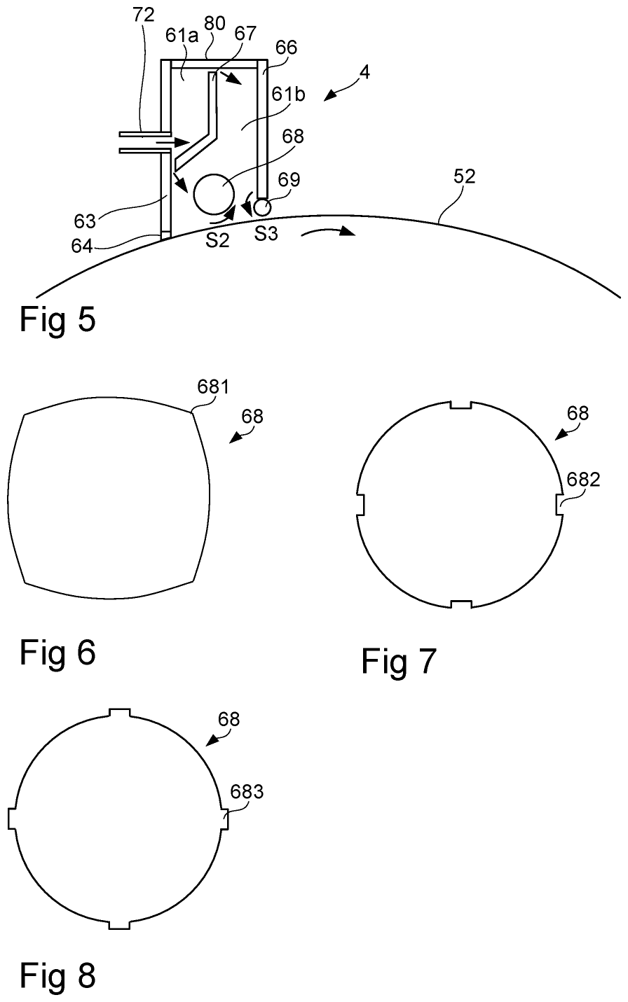

FIG. 5 schematically illustrates a further embodiment of a film forming device 4, wherein the fluidization rod 68 is positioned in the casting chamber, close to, but spaced from, the substrate 52 surface.

In this embodiment, the fluidization rod 68 may also be spaced vertically from fixed objects, such as walls 63, 66, 67 or lids 80 of the casting chamber. The fluidization rod may be vertically spaced from such objects by at least 25% of a fluidization rod radius, preferably at least 50%, at least 100% or at least 150%.

Moreover, the fluidization rod may be spaced horizontally from fixed objects, such as walls 63, 66, 67 of the casting chamber. The fluidization rod may be horizontally spaced, as seen along a movement direction of the substrate, from such objects by at least 25% of a fluidization rod radius, preferably at least 50%, at least 100% or at least 150%.

In FIG. 5, there is also illustrated an alternative embodiment of a divider wall 67, wherein the divider wall provides narrow passages from an upstream chamber portion 61a to a downstream chamber portion 61b, such narrow passages may operate so as to distribute liquid pressure over the width of the casting chamber.

The fluidization rod or rods may be designed as described with reference to FIGS. 3a-3b and 6-8.

The third shear section 44 may be designed in accordance with what was disclosed with reference to FIGS. 3a-3b or 4a-4b.

FIG. 10 schematically illustrates another version of the connection between the manifold device 7 and the casting chamber 61a, 61b, where at least some of the channels 73a-73e are provided with a regulating valve 75a-75e that is configured for regulating the flow in the respective channel 73a-73e. Preferably, such valves are configured to individually regulate the flow in very small steps or continuously.

The valves may be operatively connected to a controller, which may also be operatively connected to one or more pressure sensors. Each such pressure sensor may be arranged in an area of the casting chamber 61a, 61b which is close to a respective one of the channels 73a-73e, such that pressure in the various parts of the casting chamber may be monitored and regulated by the controller.

Alternatively, the valves may be operatively connected to a controller, which may be connected to a thickness gauge that is measuring thickness of the film in different cross-directional positions.

Hence, it is possible to further and more accurately control the pressure distribution in the casting chamber 61a, 61b, and thus the thickness distribution of the film.

The manifold device version illustrated in FIG. 10 may be applied to any of the previously discussed manifold device versions.

According to the methods disclosed herein, an MFC dispersion is dried to form a dry MFC film.

It is understood that the term “thickness” as used herein refers to actual, uncompressed thickness.

Thickness of the dry film may be measured using, as non-limiting examples, white light interferometry, laser profilometry, or optically by cutting a sample in cross-machine directional line (either cast in resin or not) and microscopic imaging (e.g. scanning electron microscopy or other applicable method) of the cut section in thickness direction.

An average dry film thickness may be on the order of 5-60 μm, 15-20 μm, preferably 20-60 μm, 10-50 μm, 30-50 μm, 15-45 μm or 20-40 μm.

Particular average dry film thicknesses may be 5-10 μm, 10-15 μm, 15-20 μm, 20-25 μm, 25-30 μm, 30-35 μm, 35-40 μm, 40-45 μm, 45-50 μm, 50-55 μm or 55-60 μm.

A dry film weight may be on the order of 4-80 g/m2, preferably 8-67 g/m2, 12-60 g/m2, 16-53 g/m2 or 20-45 g/m2.

Particular dry film weights may be 4-10 g/m2, 10-20 g/m2, 20-30 g/m2, 30-40 g/m2, 40-50 g/m2, 50-60 g/m2, 60-70 g/m2 or 70-80 g/m2.

A medium content of the dry film may be on the order of 0.1-15% by weight, preferably 1-12% by weight, or 2-10% by weight.

Particular medium content of the dry film may be on the order of 0.1-1% by weight, 1-2% by weight, 2-3% by weight, 3-4% by weight, 4-5% by weight, 5-6% by weight, 6-7% by weight, 7-8% by weight, 8-9% by weight, 9-10% by weight, 10-11% by weight, 11-12% by weight, 12-13% by weight, 13-14% by weight or 14-15% by weight.

A film forming component content of the dry film may be at least 85-99.9% by weight, with the remainder being medium.

In particular, the dry film may have an MFC content of 40-50% by weight, 50-60% by weight, 60-70% by weight, 70-80% by weight, 80-90% by weight, 90-95% by weight or 95-99% by weight.

A width of the dry film may be about 0.3-4 m, preferably 0.5-4 m, 1-4 m or 2-4 m.

Particular film widths may be 0.3-0.5 m, 0.5-1 m, 1-1.5 m, 1.5-2 m, 2-2.5 m, 2.5-3 m, 3-3.5 m or 3.5-4 m.

The dry film may be considered as a thin continuous sheet formed material. Depending on its composition, purpose and properties, the dry film may also be considered as a thin paper or web, or even as a membrane.

1. A device for applying a viscous liquid onto a moving substrate, comprising:
an inlet for a viscous liquid,
a casting chamber, a lower portion of which being open to a moving substrate, and
a metering portion, for limiting a thickness of a wet film that is formed on the moving substrate downstream of the device, and,
a shear section arranged inside the casting chamber,
the shear section comprising a fluidization rod, arranged in the casting chamber, for providing shearing of the viscous liquid inside the casting chamber.

2. The device as claimed in claim 1, wherein the shear section is configured for shearing of the viscous liquid between the shear section and the moving substrate.

3. The device as claimed in claim 1, wherein the fluidization rod extends across a width of the casting chamber.

4. The device as claimed in claim 1, wherein the fluidization rod has an effectively non-smooth surface.

5. The device as claimed in claim 1, wherein the fluidization rod is connected to a drive device configured to cause the fluidization rod to rotate.

6. The device as claimed in claim 1, wherein the metering portion comprises a metering rod.

7. The device as claimed in claim 6, wherein the metering rod has a downwardly convex surface.

8. (canceled)

9. The device as claimed in claim 6, wherein the metering rod is rotatable.

10. (canceled)

11. (canceled)

12. The device as claimed in claim 6, wherein the metering rod is non-rotatable.

13. The device as claimed in claim 12, wherein the metering rod has a release edge extending axially of the metering rod.

14. (canceled)

15. The device as claimed in claim 1, wherein the metering portion comprises an upper lip, wherein an application slot is formed between the upper lip and the moving substrate.

16. The device as claimed in claim 1, wherein the fluidization rod is upwardly spaced from any fixed object in the casting chamber by a distance of at least 25% of a radius of the fluidization rod.

17. The device as claimed in claim 1, wherein the fluidization rod is spaced in the upstream direction from any fixed object in the casting chamber by a distance of at least 25% of a radius of the fluidization rod.

18. The device as claimed in claim 1, further comprising:
a divider wall, which divides the casting chamber into an upstream section and a downstream section.

19. The device as claimed in claim 18, wherein the shear section is configured to provide said shearing of the viscous liquid when the viscous liquid passes from the upstream section towards the downstream section.

20. The device as claimed in claim 1, further comprising:
a manifold device configured to divide the inlet into at least two inlet subflow channels, which connect to the casting chamber, wherein the inlet subflow channels are spaced from each other along said casting chamber width.

21. The device as claimed in claim 20, wherein at least some of the subflow channels present a regulating valve, configured for regulating a flow in the respective subflow channel.

22. (canceled)

23.-25. (canceled)

26. A system for producing a film from an MFC dispersion, comprising:
a substrate, onto which a film is to be formed, and
the device as claimed in claim 1, arranged such that a lower portion of the casting chamber is open to the substrate.

27. The system as claimed in claim 26, further comprising:
a drying section, wherein the substrate is configured to be passed through the drying section downstream of the device.

28. The system as claimed in claim 26, wherein the substrate is an endless steel belt.

29. The system as claimed in claim 26, wherein the metering portion presents a gap, which is limited in one direction by the substrate.

30. A method of producing an MFC film, comprising:
providing an MFC dispersion,
applying the MFC dispersion onto a surface of the moving substrate with the device of claim 1, while the moving substrate is caused to move relative to the device, such that a wet MFC film is formed on the substrate, and
subjecting the wet MFC film to a drying process to remove liquid from the MFC dispersion.

31. The method as claimed in claim 30, wherein the MFC dispersion comprises a film forming component which is distributed in a medium that is to be essentially removed, wherein a content of the medium of the MFC dispersion is at least 75% by weight.

32. The method as claimed in claim 30, wherein the MFC dispersion has a solids content of about 2.5-25% by weight, and a viscosity which is above about 4 Pas at a shear rate of 20 s⁻¹.

33.-39. (canceled)
